(19) United States
(12) Patent Application Publication
(10) Pub. No.: US 2018/0270515 A1
(43) Pub. Date: Sep. 20, 2018

(54) METHODS AND SYSTEMS FOR CLIENT INTERPRETATION AND PRESENTATION OF ZOOM-CODED CONTENT

(71) Applicant: Vid Scale, Inc., Wilmington, DE (US)

(72) Inventors: Kumar Ramaswamy, Princeton, NJ (US); Jeffrey Allen Cooper, Rocky Hill, NJ (US)

(21) Appl. No.: 15/764,806

(22) PCT Filed: Sep. 23, 2016
(86) PCT No.: PCT/US16/53512

§ 371 Date: Mar. 29, 2018

Related U.S. Application Data
(60) Provisional application No. 62/236,023, filed on Oct. 1, 2015.

(51) Int. Cl. H04N 21/2343; H04N 19/20

(52) U.S. Cl. CPC H04N 21/234345; H04N 19/20; H04N 21/234309; H04N 21/23439; H04N 21/234363

(57) ABSTRACT

Described embodiments relate to systems and methods for displaying information regarding tracked objects and receiving user input selecting the object(s) to be tracked. One embodiment takes the form of a method that includes: receiving, from a content server, a first representation of a video stream and an object-of-information identifier that indicates availability of a second representation of a portion of the video stream that depicts an object of interest; causing the display of both the first representation of the video stream and the object-of-interest identifier; responsive to a selection of the second representation of the portion of the video stream using the object-of-interest identifier, transmitting, to the content server, a request for the second representation of the portion of the video stream; and receiving and causing display of the second representation of the portion of the video stream.

### CROSS-REFERENCE TO RELATED APPLICATIONS

The present application claims priority to U.S. Provisional Application Ser. No. 62/236,023 filed Oct. 1, 2015, titled “METHOD AND SYSTEMS FOR CLIENT INTERPRETATION AND PRESENTATION OF ZOOM-CODED CONTENT.”

### BACKGROUND

Digital video signals are commonly characterized by parameters including i) resolution (e.g. luma and chroma resolution or horizontal and vertical pixel dimensions), ii) frame rate, and iii) dynamic range or bit depth (e.g. bits per pixel). The resolution of digital video signals has increased from Standard Definition (SD) through 8K-Ultra High Definition (UHD). The other digital video signal parameters have also improved, with frame rate increasing from 30 frames per second (fps) up to 240 fps and bit depth increasing from 8 bit to 12 bit. To transmit a digital video signal over a network, MPEG/ITU standardized video compression has undergone several generations of successive improvements in compression efficiency, including MPEG2, MPEG4 part 2, MPEG-4 part 10/H.264, and HEVC/H.265. The technology to display the digital video signals on a consumer device, such as a television or mobile phone, has also increased correspondingly.

Consumers requesting higher quality digital video on network-connected devices face bandwidth constraints from video content delivery networks. In an effort to mitigate the effects of bandwidth constraints, several solutions have emerged. Video content is initially captured at a higher resolution, frame rate, and dynamic range than will be used for distribution. For example, a 4:2:2, 10 bit HD video content is often down-resolved to a 4:2:0, 8 bit format for distribution. The digital video is encoded and stored at multiple resolutions at a server, and these versions at varying resolutions are made available for retrieval, decoding and rendering by clients with possibly varying capabilities. The digital video is encoded and stored at multiple resolutions at a server. Adaptive bit rate (ABR) further addresses network congestion. In ABR, a digital video is encoded at multiple bit rates (e.g.: choosing the same or multiple lower resolutions, lower frame rates, etc.) and these alternate versions at different bit rates are made available at a server. The client device may request a different bit rate version of the video content for consumption at periodic intervals based on the client's calculated available network bandwidth or local computing resources.

### SUMMARY

Zoom coding provides an ability to track objects of interest in a video, providing the user with the opportunity to track and view those objects at the highest available resolution (e.g., at the original capture resolution). Zoom coding provides this ability on a user's request for alternative stream delivery. In general, in addition to creating the Adaptive Bit Rate streams in a standard ABR delivery system, zoom coding allows creation of streams that track specific objects of interest at a high resolution (e.g. at a resolution higher than a normal viewing resolution of the video content).

Described embodiments relate to systems and methods for displaying information regarding what objects are available to be tracked (e.g. in the form of a zoom coded stream) and for receiving user input selecting the object or objects to be tracked.

A headend encoder creates zoom coded streams based on a determination of what objects a viewer should be able to track. The determination may be made automatically or may be based on human selection. In some embodiments, the availability of trackable objects is signaled to a client using out-of-band mechanisms. Systems and methods disclosed herein enable a client that has received such information on trackable objects to inform the end user as to what objects may be tracked. In some embodiments, this information is provided visually. Embodiments described herein provide techniques for displaying to an end user the available choices of objects. Users may select an available trackable object (e.g. using a cursor or other selection mechanism), which leads the client to retrieve the appropriate zoom coded stream from the server.

One embodiment takes the form of a method, the method including: receiving, from a content server, a first representation of a video stream and an object-of-information identifier, the object-of-information identifier indicating availability of a second representation of a portion of the video stream that depicts an object of interest; causing the display of both the first representation of the video stream and the object-of-interest identifier; responsive to a user selection of the second representation of the portion of the video stream, transmitting, to the content server, a request for the second representation of the portion of the video stream; receiving the second representation of the portion of the video stream; and causing display of the second representation of the portion of the video stream.

### BRIEF DESCRIPTION OF THE DRAWINGS

A more detailed understanding may be had from the following description, presented by way of example in conjunction with the accompanying figures. The accompanying figures, where like reference numerals refer to identical or functionally similar elements throughout the separate views, together with the detailed description below, are incorporated in and form part of the specification and serve to further illustrate embodiments of concepts that include the claimed invention, and explain various principles and advantages of those embodiments.

FIG. 1A depicts an example communications system in which one or more disclosed embodiments may be implemented.

FIG. 1B depicts an example client device that may be used within the communications system of FIG. 1A.

FIG. 2 depicts an example coding system, according to an embodiment.

FIG. 3 depicts an example user interface presentation, in accordance with an embodiment.

FIG. 4 depicts a second example user interface presentation, in accordance with an embodiment.

FIG. 5 depicts a third example user interface presentation, in accordance with an embodiment.

FIG. 6 depicts a fourth example user interface presentation, in accordance with an embodiment.

FIG. 7 depicts an example of an overall flow, including presentation of zoomcoded streams to a user, of the zoom coding scheme, in accordance with an embodiment.

FIG. 8 depicts an example of an information exchange (with the individual slice requests) for an exemplary Dynamic Adaptive Streaming over HTTP (DASH)-type session, in accordance with an embodiment.

FIG. 9 depicts an example method, in accordance with an embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

One embodiment takes the form of a method that includes receiving, from a content server, a first representation of a video stream and an object-of-interest identifier, the object-of-interest identifier indicating availability of a second representation of a portion of the video stream that depicts an object of interest (e.g. an enhanced view of an object of interest); causing the display of both the first representation of the video stream and the object-of-interest identifier; responsive to a selection of the second representation of the portion of the video stream using the object-of-interest identifier, transmitting, to the content server, a request for the second representation of the portion of the video stream; receiving the second representation of the portion of the video stream; and causing display of the second representation of the portion of the video stream.

Another embodiment takes the form of a system that includes a communication interface, a processor, and data storage containing instructions executable by the processor for carrying out at least the functions described in the preceding paragraph.

In at least one embodiment, the portion of the video stream that depicts an object of interest is an enlarged portion of the video stream.

In at least one embodiment, the object of interest is a tracked object in the video stream.

In at least one embodiment, causing the display of the object-of-interest identifier comprises displaying a rectangle bounding the portion of the video stream overlaid on the first representation of the video stream.

In at least one embodiment, causing the display of the object-of-interest identifier comprises displaying text descriptive of the object of interest. In one such embodiment, the object of interest is a person and the descriptive text is a name of the person.

In at least one embodiment, causing the display of the object-of-interest identifier comprises displaying a still image of the object of interest.

In at least one embodiment, the method further includes displaying a digit in proximity to the object-of-interest identifier and wherein the user selection comprises detecting the digit being selected in a user interface.

In at least one embodiment, causing the display of the object-of-interest identifier comprises displaying a timeline that indicates times during the video stream that the second representation of the portion of the video stream is available.

In at least one embodiment, causing the display of the object-of-interest identifier comprises displaying the object-of-interest identifier in a sidebar menu.

In at least one embodiment, the object-of-interest identifier is received in a manifest file.

In at least one embodiment, the first representation of the video stream is at a first bit-rate and the second representation of the portion of the video stream is at a second bit-rate different from the first bit-rate.

In at least one embodiment, the video stream is a pre-recorded video stream.

In at least one embodiment, the representations of the video streams are displayed on a device selected from the group consisting of: a television, a smart phone screen, a computer monitor, a wearable device screen, and a tablet screen.

In at least one embodiment, the timeline displays indication of availability of second representations of the portions of the video stream for at least two different objects of interest, wherein the indication of availability of each different object of interest is indicated by a different color.

In at least one embodiment, the timeline comprises a stacked timeline having multiple rows, each row in the multiple rows corresponds to a different tracked object for which a second representation is available.

In at least one embodiment, the selection comprises a desired playback time along the timeline, and causing display of the second representation of the portion of the video stream comprises displaying the second representation at the desired playback time.

In at least one embodiment, the selection is a user selection of the second representation.

In at least one embodiment, the selection is an automatic selection by the client device based on previously obtained user preferences.

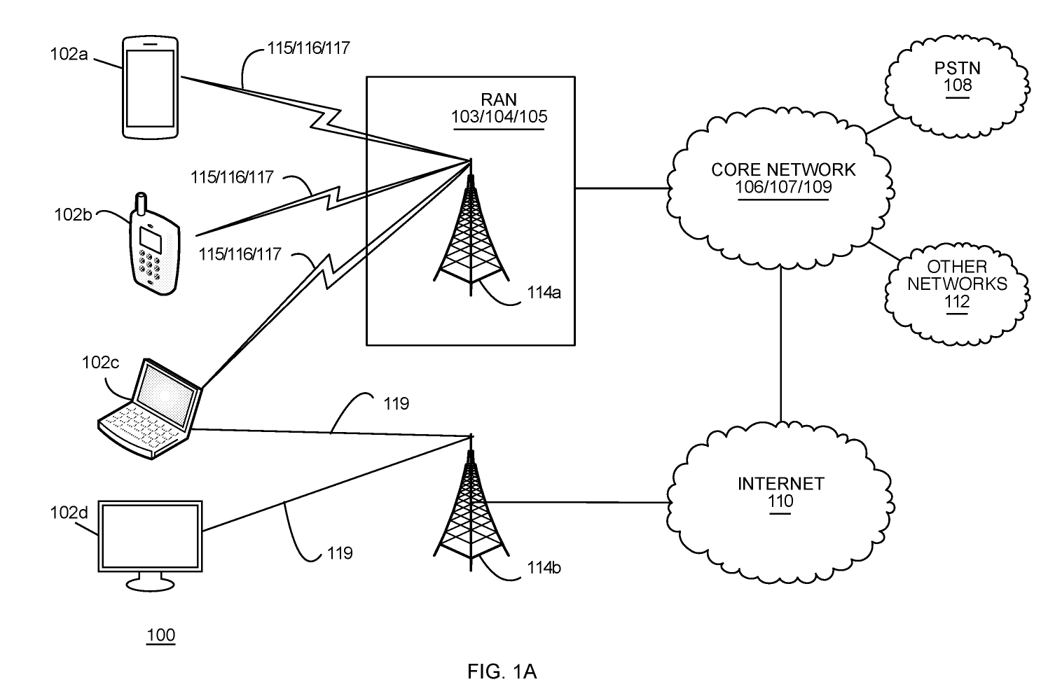

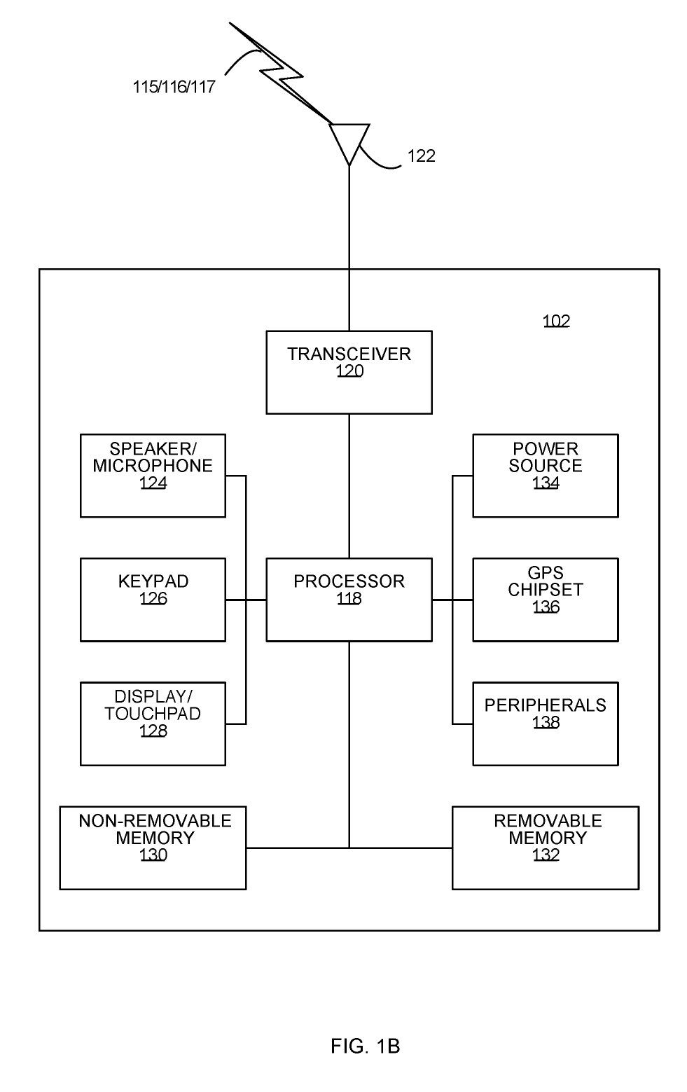

A detailed description of illustrative embodiments will now be provided with reference to the various figures. Although this description provides detailed examples of possible implementations, it should be noted that the provided details are intended to be by way of example and in no way limit the scope of the application. The systems and methods relating to video compression may be used with the wired and wireless communication systems described with respect to FIGS. 1A and 1B. As an initial matter, these wired and wireless systems will be described.

FIG. 1A is a diagram of an example communications system 100 in which one or more disclosed embodiments may be implemented. The communications system 100 may be a multiple access system that provides content, such as voice, data, video, messaging, broadcast, and the like, to multiple wireless users. The communications system 100 may enable multiple wired and wireless users to access such content through the sharing of system resources, including wired and wireless bandwidth. For example, the communications systems 100 may employ one or more channel-access methods, such as code division multiple access (CDMA), time division multiple access (TDMA), frequency division multiple access (FDMA), orthogonal FDMA (OFDMA), single-carrier FDMA (SC-FDMA), and the like. The communications systems 100 may also employ one or more wired communications standards (e.g.: Ethernet, DSL, radio frequency (RF) over coaxial cable, fiber optics, and the like.

As shown in FIG. 1A, the communications system 100 may include client devices 102a, 102b, 102c, and/or 102d, Radio Access Networks (RAN) 103/104/105, a core network 106/107/109, a public switched telephone network (PSTN) 108, the Internet 110, and other networks 112, and communication links 115/116/117, and 119, though it will be appreciated that the disclosed embodiments contemplate any number of client devices, base stations, networks, and/or network elements. Each of the client devices 102a, 102b, 102c, 102d may be any type of device configured to operate and/or communicate in a wired or wireless environment. By way of example, the client device 102a is depicted as a tablet computer, the client device 102b is depicted as a smart phone, the client device 102c is depicted as a computer, and the client device 102d is depicted as a television.

The communications systems 100 may also include a base station 114a and a base station 114b. Each of the base stations 114a, 114b may be any type of device configured to wirelessly interface with at least one of the client devices 102a, 102b, 102c, 102d to facilitate access to one or more communication networks, such as the core network 106/107/109, the Internet 110, and/or the networks 112. The client devices may be different wireless transmit/receive units (WTRU). By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, and the like. The base station 114a and/or the base station 114b may be configured to transmit and/or receive wireless signals within a particular geographic region, which may be referred to as a cell (not shown). The cell may further be divided into sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the client devices 102a, 102b, 102c, and 102d over an air interface 115/116/117, or communication link 119, which may be any suitable wired or wireless communication link (e.g., radio frequency (RF), microwave, infrared (IR), ultraviolet (UV), visible light, and the like). The air interface 115/116/117 may be established using any suitable radio access technology (RAT).

More specifically, as noted above, the communications system 100 may be a multiple access system and may employ one or more channel-access schemes, such as CDMA, TDMA, FDMA, OFDMA, SC-FDMA, and the like. For example, the base station 114a in the RAN 103/104/105 and the client devices 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the client devices 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the client devices 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wired router, a wireless router, Home Node B, Home eNode B, or access point, as examples, and may utilize any suitable wired transmission standard or RAT for facilitating wireless connectivity in a localized area, such as a place of business, a home, a vehicle, a campus, and the like. In one embodiment, the base station 114b and the client devices 102c, 102d may implement a radio technology such as IEEE 802.11 to establish a wireless local area network (WLAN). In another embodiment, the base station 114b and the client devices 102c, 102d may implement a radio technology such as IEEE 802.15 to establish a wireless personal area network (WPAN). In yet another embodiment, the base station 114b and the client devices 102c, 102d may utilize a cellular-based RAT (e.g., WCDMA, CDMA2000, GSM, LTE, LTE-A, and the like) to establish a picocell or femtocell. In yet another embodiment, the base station 114b communicates with client devices 102a, 102b, 102c, and 102d through communication links 119. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, applications, and/or voice over internet protocol (VoIP) services to one or more of the client devices 102a, 102b, 102c, 102d. As examples, the core network 106/107/109 may provide call control, billing services, mobile location-based services, pre-paid calling, Internet connectivity, video distribution, and the like, and/or perform high-level security functions, such as user authentication. Although not shown in FIG. 1A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the client devices 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and IP in the TCP/IP Internet protocol suite. The networks 112 may include wired and/or wireless communications networks owned and/or operated by other service providers. For example, the networks 112 may include another core network connected to one or more RANs, which may employ the same RAT as the RAN 103/104/105 or a different RAT.

Some or all of the client devices 102a, 102b, 102c, 102d in the communications system 100 may include multi-mode capabilities, i.e., the client devices 102a, 102b, 102c, 102d may include multiple transceivers for communicating with different wired or wireless networks over different communication links. For example, the WTRU 102c shown in FIG. 1A may be configured to communicate with the base station 114a, which may employ a cellular-based radio technology, and with the base station 114b, which may employ an IEEE 802 radio technology.

FIG. 1B depicts an example client device that may be used within the communications system of FIG. 1A. In particular, FIG. 1B is a system diagram of an example client device 102. As shown in FIG. 1B, the client device 102 may include a processor 118, a transceiver 120, a transmit/receive element 122, a speaker/microphone 124, a keypad 126, a display/touchpad 128, a non-removable memory 130, a removable memory 132, a power source 134, a global positioning system (GPS) chipset 136, and other peripherals 138. It will be appreciated that the client device 102 may represent any of the client devices 102a, 102b, 102c, and 102d, and include any sub-combination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home Node-B, an evolved home Node-B (eNodeB), a home evolved Node-B (HeNB), a home evolved Node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the client device 102 to operate in a wired or wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117 or communication link 119. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, as examples. In yet another embodiment, the transmit/receive element 122 may be configured to transmit and receive both RF and light signals. In yet another embodiment, the transmit/receive element may be a wired communication port, such as an Ethernet port. It will be appreciated that the transmit/receive element 122 may be configured to transmit and/or receive any combination of wired or wireless signals.

In addition, although the transmit/receive element 122 is depicted in FIG. 1B as a single element, the client device 102 may include any number of transmit/receive elements 122. More specifically, the client device 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the client device 102 may have multi-mode capabilities. Thus, the transceiver 120 may include multiple transceivers for enabling the client device 102 to communicate via multiple RATs, such as UTRA and IEEE 802.11, as examples.

The processor 118 of the client device 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the client device 102, such as on a server or a home computer (not shown).

The processor 118 may receive power from the power source 134, and may be configured to distribute and/or control the power to the other components in the client device 102. The power source 134 may be any suitable device for powering the WTRU 102. As examples, the power source 134 may include one or more dry cell batteries (e.g., nickel-cadmium (NiCd), nickel-zinc (NiZn), nickel metal hydride (NiMH), lithium-ion (Li-ion), and the like), solar cells, fuel cells, a wall outlet and the like.

The processor 118 may also be coupled to the GPS chipset 136, which may be configured to provide location information (e.g., longitude and latitude) regarding the current location of the client device 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the client device 102 may acquire location information by way of any suitable location-determination method while remaining consistent with an embodiment. In accordance with an embodiment, the client device 102 does not comprise a GPS chipset and does not acquire location information.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

### Zoom Coding.

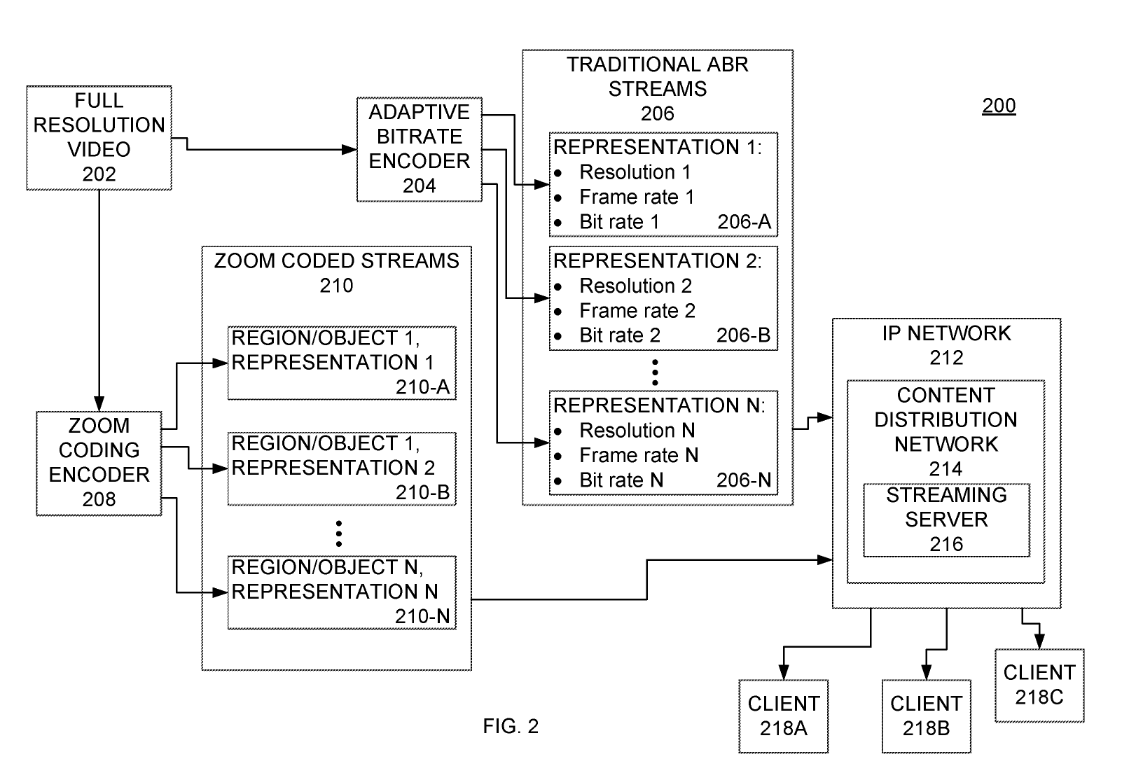

FIG. 2 depicts the overall flow of zoom coding in the context of Adaptive Bit Rate mechanisms that are used to stream from the server to the client. As shown, FIG. 2 depicts system 200, which includes an input video stream 202, an adaptive bitrate encoder 204, a zoom coding encoder 208, a streaming server 216, an Internet Protocol (IP) network 212 that includes a content distribution network 214, and client devices 218A-C. The example system 200 may take place in the context of the example communication system 100 depicted in FIG. 1A. For example, both the adaptive bitrate (ABR) encoder 204 and the streaming server 216 may be entities in any of the networks depicted in the communication system 100. The client devices 218A-C may be the client devices 102a-d depicted in the communication system 100.

The zoom coding encoder 208 receives the source video stream either in uncompressed or a previously compressed format, encodes or transcodes the source video stream into a plurality of zoom coded streams 210, wherein each of the zoom coded streams represents a portion (e.g. a slice, a segment, or a quadrant) of the overall source video. The zoom coded streams may be encoded at a higher resolution than traditional reduced resolution ABR streams. In some embodiments, the zoom coded streams are encoded at the full capture resolution. Consider an embodiment in which the source video stream has a resolution of 4K. The corresponding ABR representations may be at HD and lower resolutions. A corresponding zoom-coded stream may also be at HD resolution, but this may correspond to the capture resolution for the zoomed section. Here, the zoom coded streams are represented by stream 210-A of a first object at a first representation, stream 210-B of the first object at a second representation, and any other number of objects and representations are depicted by stream 210-N.

In embodiments using transcoding that convert a video stream from one compressed format to another, a decoding process is performed that brings the video back to the uncompressed domain at its full resolution followed by the re-encoding process of creating new compressed video streams which may, for example, represent different resolutions, bit rates or frame rates. The zoom coded streams 210 may be encoded at the original resolution of the source video and/or at one or more lower resolutions. In some embodiments, the resolutions of the zoom coded streams are higher than the resolutions of the un-zoomed ABR streams. The zoom coded streams are transmitted to or placed onto the streaming server for further transmission to the client devices. In some embodiments, the ABR encoder 204 and the zoom coding encoder 208 are the same encoder, configured to encode the source video into the ABR streams and the zoom coded streams.

In accordance with an embodiment, the adaptive bitrate encoder 204 or transcoder receives an uncompressed or compressed input video stream and encodes or transcodes the video stream into a plurality of representations 206. The plurality of representations may vary the resolution, frame rate, bit rate, and/or the like and are represented by the streams 206-A, 206-B, and 206-N. The encoded video streams according to the plurality of representations may be transferred to the streaming server 216. The streaming server 216 transmits encoded video streams via the network (212 and/or 214) to the client devices 218A-C. The transmission may take place over any of the available communication interfaces, such as the communication link 115/116/117 or 119.

### Interpretation of Zoom Coded Content.

In general, for a given video sequence, it is possible to create any number of zoom coded streams, with at least some of the zoom coded streams being associated with one or more tracked objects. A tracked object may be, e.g., a ball, a player, a person, a car, a building, a soccer goal, or any object which may be tracked and for which a zoom coded stream may be available.

Various techniques for object tracking are described in, for example, A. Yilmaz, O. Javed, M. Shah, “Object Tracking—A Survey”, ACM Computing Surveys, Vol. 38, No. 4, Article 13, December 2006. Based on the type of content, an encoder may choose from the available techniques to track moving objects of interest and hence may generate one or more object-centric regions of interest.

An example scenario is the following. The encoder creates two additional zoom coded streams in addition to the original stream. The availability of the encoded streams is communicated to the client by the streaming server in the form of an out-of-band “manifest” file. This is done periodically depending on how often the encoder changes objects of interest to be tracked. The stream information may be efficiently communicated in the client in the form of (x, y) coordinates and information regarding the size of a window for each zoom coded stream option. This stream information may be sent in the manifest information as supplemental data. A legacy client would ignore this stream information since it is unable to interpret this supplemental data field. However, a client capable of processing zoom coded streams is able to interpret the stream information and stores it for rendering (e.g. if an end user requests to use a zoom coding feature). In some embodiments, the end user in the normal course of watching a program may request to see if there are any zoom coded streams available. In some embodiments, this could be done in the form of a simple IR command from a remote control (e.g. a special one-touch button that sends a request back to the set-top box (STB) or other client device to highlight on a still image the other zoom coded objects that are being tracked and could hence be requested for viewing). In embodiments including a two-way interactive device (such as a tablet or phone), the interface can be even richer. For example, a user may tap the touch screen of a two-way interactive device to bring up an interface which may identify the available zoom-coded objects, and selection and/or interaction with the zoom-coded objects may be realized via the touch screen interface of the device. The requests may be implemented with a button on the client device (or remote control thereof) that, when pressed, leads to interpretation and/or display of the manifest information and shows to the user what zoom coded objects may be viewed.

In some embodiments, a rendering reference point or “render point” may be provided for a tracked object to indicate a rendering position associated with one or more positions of the tracked object (or region) of interest. The rendering reference point may, for example, indicate a position (e.g. a corner or an origin point) of a renderable region which contains the object of interest at some point in time. The rendering reference point may indicate a size or extent of the renderable region. The rendering reference point may define a bounding box which defines the location and extent of the object/area of interest or of the renderable region containing the object/area of interest. The client may use the rendering reference point information to extract the renderable region from one or multiple zoom-coded streams or segments, and may render the region as a zoomed region of interest on the client display. The rendering reference points may be communicated to the client device. For example, rendering reference points may be transmitted in-band as part of the video streams or video segments, or as side information sent along with the video streams or video segments. Alternately the rendering reference points may be specified in an out-of-band communication (e.g. as metadata in a file such as a DASH MPD). The rendering reference point as communicated to the client may be updated on a frame-by-frame basis, which may allow the client to continuously vary the location of the extracted renderable region, and so the object of interest may be smoothly tracked on the client display. Alternatively, the rendering reference point may be updated more coarsely in time, in which case the client may interpolate the rendering position between updates in order to smoothly track the object of interest when displaying the renderable region on the client display. The rendering reference point comprises two parameters, a vertical distance and a horizontal distance represented by: (x, y). The rendering reference points may, for example, be communicated as supplemental enhancement information (SEI) messages to the client device.

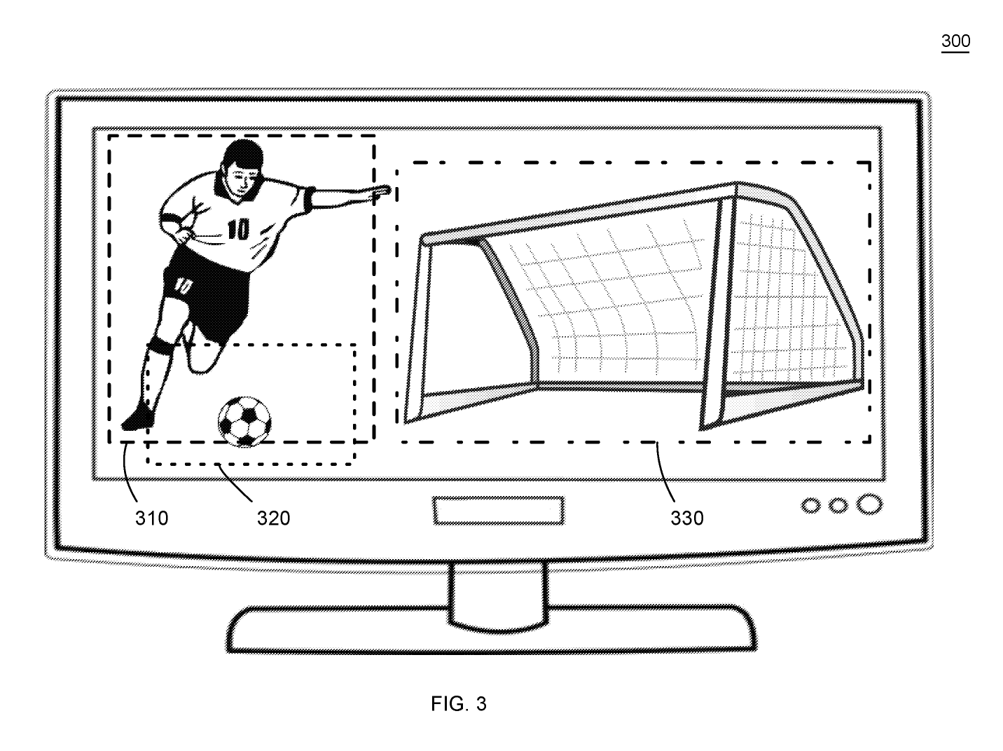

FIG. 3 depicts an example user interface presentation, in accordance with an embodiment. The exemplary user interface allows a user to select a zoom coded stream for viewing. As shown, FIG. 3 depicts the view 300 that includes a client device displaying a static image on the client device with three regions corresponding to three available zoom coded streams, however any number of available zoom coded streams may be possible. While FIG. 3 depicts a static image, the client device may present a video stream, and the location of each region may be highlighted in the display as the different objects change location within the video stream. Region 310 depicts a zoom coded stream capturing a soccer player, region 320 depicts a zoom coded stream capturing a soccer ball, while region 330 depicts a zoom coded stream capturing a soccer goal. Regions 310, 320, and 330 are shown to illustrate that zoom coded streams may track people (or animals), objects (the soccer ball), and/or regions (the soccer goal area), however this should not be construed as limiting. The example given in FIG. 3 is for soccer, but should not be considered as limiting.

In FIG. 3, in addition to encoding the normal program, the encoder creates zoom coded streams of objects of interest (e.g. corresponding to the different regions 310, 320, and 330). The zoom coded streams may represent zoomed views (e.g. full-resolution views) of objects tracked in the video content. Information which identifies and/or provides access to the zoom coded streams (such as an object-of-interest identifier for each object of interest) may be constantly communicated, either in-band in the video content, or out-of-band (e.g. in the manifest file, which may be periodically updated). In some embodiments, when the user requests information as to what zoom coded views are available, the user receives a static image representation (e.g. the last frame decoded by the client, or the most recent instantaneous decoder refresh (IDR) frame) with a graphic overlay (e.g. the rectangular boxes 310, 320, and 330 depicted in FIG. 3) which may identify the zoom coded stream options. In some embodiments, the zoom coded representational views may be in the form of a lower resolution compressed video sequence. In some embodiments, the color of the overlay representation may be varied depending on the background information (e.g. the background color and/or texture) of the underlying static image. The boxes may then be presented in a color or colors that contrast with the background. In other embodiments, the color of the boxes is user selectable. In different embodiments, the user is provided with different options for selecting the available objects. In a first embodiment, a timeline indicator at the bottom of a display presented by the client device shows (e.g. by a color coding) if one or more zoom-able/trackable objects of interest have been available in the past (e.g. in a live streaming situation). In an exemplary video on demand (VOD) playback system, there is a forward and backward timeline that indicates the past and future availability of one or more objects of interest with a color-coding and a legend to indicate how to interpret the color-coding. In such embodiments, the headend may communicate metadata to the client device regarding the availability of objects (in the past for live, or in both the past and future for on-demand). The client device interprets the metadata. Information regarding the availability of objects is then displayed either continuously or on demand to the user, thus enabling the selection of such available objects or regions of interest. Embodiments described herein operate by translating the zoom coded manifest information into a user interface element at the client device that makes it visually easy for the end user to understand what zoom coded streams are available (and possibly at what times along a timeline such zoom coded streams are available) and to select an available stream.

There are many alternative user interface presentations of the metadata information from the server. In FIG. 3, an embodiment is illustrated using a static image with the trackable objects being outlined by a bounding box. In alternative embodiments, instead of being overlaid on a static image, the user interface is overlaid on a moving image, such as a video image (e.g. a looped video clip marked up to identify the highlighted objects).

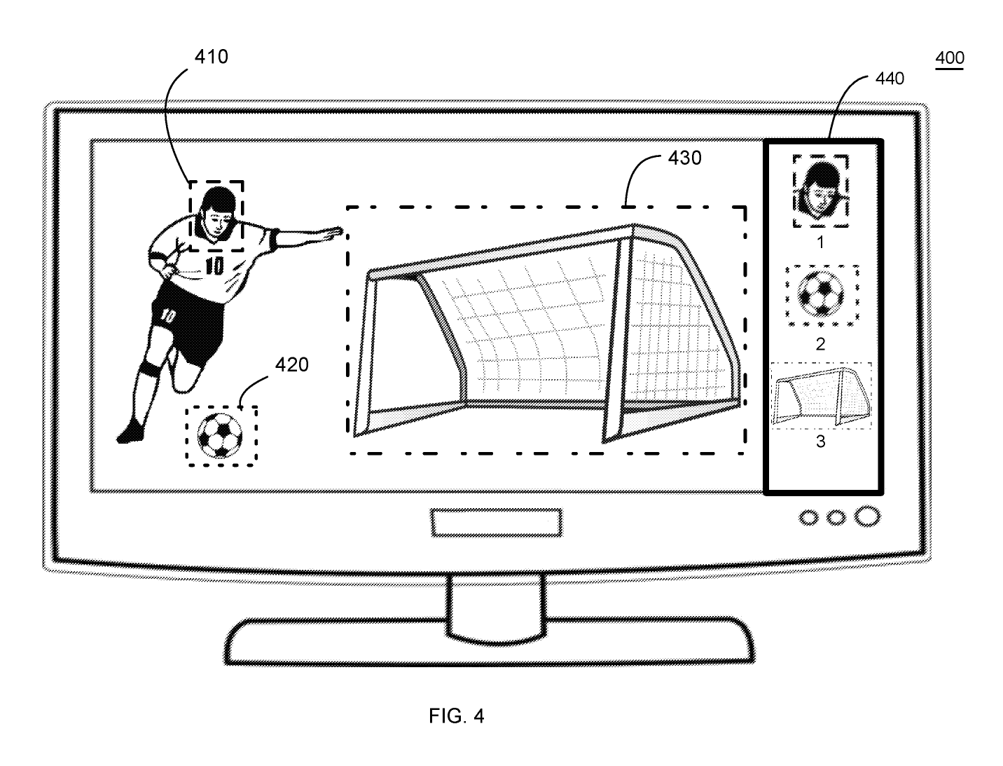

FIG. 4 depicts a second example user interface presentation, in accordance with an embodiment. Similar to the view 300 of FIG. 3, FIG. 4 depicts the view 400 that includes a client device displaying a representation of specific objects within the video being tracked over time. In some embodiments, this representation is usable for VOD content. At the beginning of the content presentation, metadata indicating zoom coded streams containing specific players is communicated (while players are used in this sports example, the zoom coded streams may refer to any tracked object for which a zoom coded stream is available). The user may select a player to track using a user interface. Based on the user's choice of player to be tracked, different zoom coded segments containing the selected player or portions of the selected player are delivered from the VOD server to the client device.

The view 400 includes the same video content image as FIG. 3, and the same person/object/region of 310/320/330 are being tracked, respectively. However, while the graphic overlays of FIG. 3 show the area of the entire zoom coded stream (what would be displayed on the screen if selected), FIG. 4 highlights portions of interest within the available zoom coded streams. For example, graphic overlay 410 highlights the soccer player's face, however the zoom coded stream that could be displayed if region 410 is selected could be the region highlighted by graphic overlay 310 in FIG. 3. Similarly, graphic overlay 420 highlights only the soccer ball, however if 420 is selected, a larger region including the soccer ball could be displayed (e.g. region 320 of FIG. 3). FIG. 4 further depicts a side panel 440 in the display interface. Side panel 440 may include (but is not limited to) pictures of the highlighted objects of the available zoom coded streams, as well as numerical indices that may be used to select the desired zoom coded stream. Metadata (e.g. in a manifest file such as an MPD file delivered to the client) may contain information identifying the portions of interest (e.g. portions of interest 410, 420, and 430) which may correspond to the trackable objects for which zoom coded streams are available.

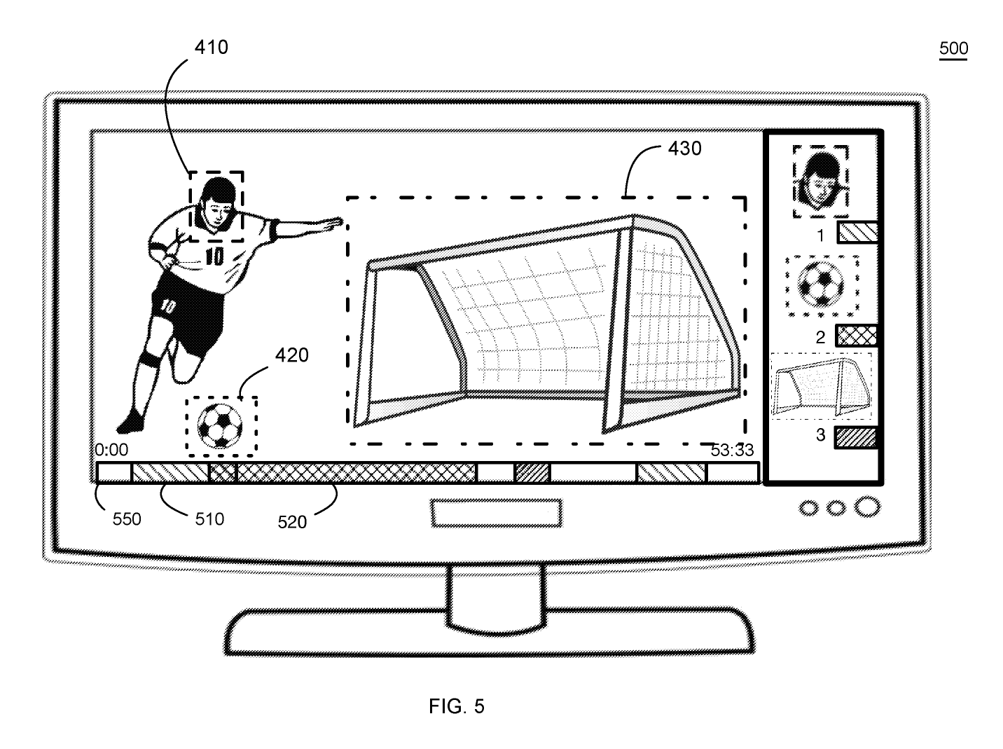

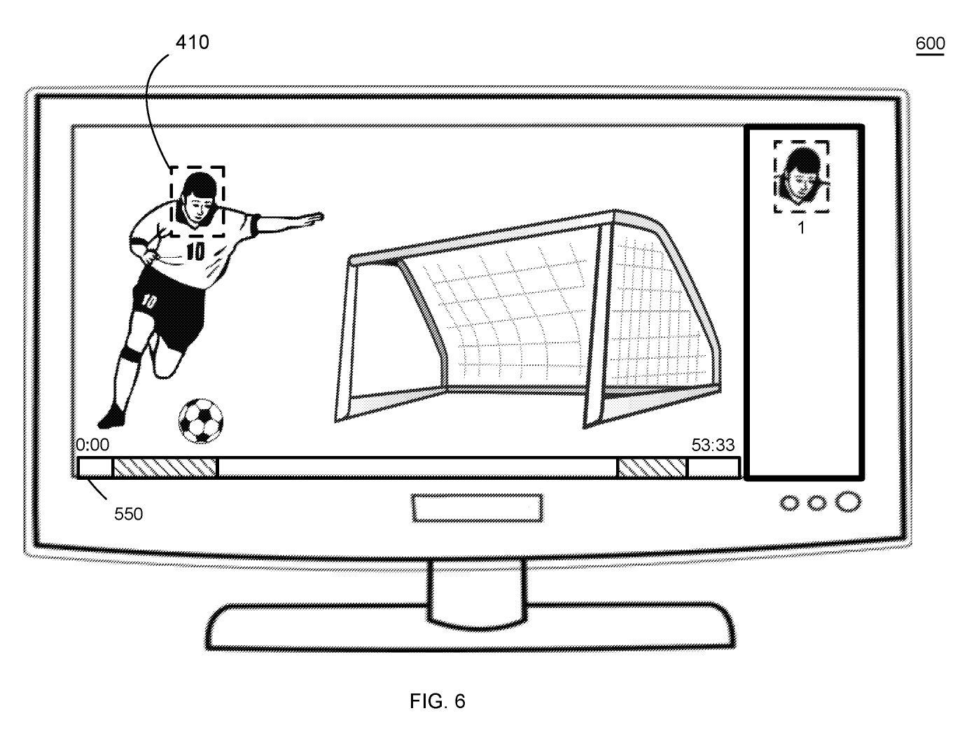

FIG. 5 depicts a third example user interface presentation of the display interface. As shown, FIG. 5 depicts the view 500 that is similar to the views 300 and 400, but further includes an object-annotated timeline indicator 550. The timeline indicator may be used to show points in time (e.g. time intervals) for which certain objects of interest or their associated zoom coded streams are available. In a first embodiment, the timeline indicator may depict multiple zoom coded streams, as shown in FIG. 5. The time indications for each zoom coded stream may be color coded, or include different patterns (as shown) in order to distinguish between them. In some embodiments, a legend may be given. The legend is depicted in FIG. 5 within the side panel; however, other embodiments are available as well. Often times, multiple streams may be available at the same instant, and it may be difficult to tell when some zoom coded streams are available during an overlap. In FIG. 5, the time indications 510 and 520 (representing availability of objects 410 and 420, respectively) have overlap, and it may be difficult to tell when 510 ends or when 520 begins. In some embodiments, the user may select a zoom coded stream and the timeline indicator will display only available times for the selected zoom coded stream. Such an embodiment is depicted in the view 600 of FIG. 6.

FIG. 6 depicts a fourth example user interface presentation, in accordance with an embodiment. In FIG. 6, the user has selected the zoom coded stream associated with soccer player 410, and only time indications for the selected zoom coded stream are shown.

In further embodiments, a representation of all available zoom coded segments of the object(s) of interest may be shown. A single timeline row with color-coded or pattern-coded regions may be used, as depicted by FIG. 6. An alternate visual depiction may use multiple timeline rows wherein each of the multiple timeline rows corresponds to a tracked object for which a zoom coded stream is available. The multiple timeline rows may be displayed in a vertically disjoint or stacked form, so that the user may be able to interpret clearly the time intervals for which multiple objects overlap in availability. As shown in the example of FIG. 6, the object may be a player in sports. All available zoom coded segments for the specific player for the entire sequence are shown to the end user. An even further embodiment includes all zoom coded sequences for all objects. In order to enable this feature, the headend communicates out-of-band metadata (which may be in the form of private data) with, for example, the following information:
Total content length
Total number of tracked objects (including inanimate objects, characters, and regions of interest (ROIs), and the like)
For each tracked object, an indication of the start time and duration of tracking. If an object appears multiple times, then information is provided on the start times and durations for each of the times the entity appears.
For each tracked object, information specifying a rectangular box or highlight boundary for the tracked object (see FIG. 3) corresponding to at least one example frame (e.g. a ‘static frame’ onto which a user interface may be overlaid).
For each tracked object, information specifying a representative portion of interest within the zoom coded stream for the tracked object (FIG. 4) corresponding to at least one example frame (e.g. ‘static frame’ onto which a user interface may be overlaid).

At the client device, the metadata described above may be interpreted and presented in a variety of ways. For example, in one embodiment, the aggregate information may be presented at the bottom of the screen with the timeline and the objects/characters/ROIs displayed in icons on the side panel as illustrated in FIG. 5. In some embodiments, when characters or objects are being tracked, all trackable objects or characters are shown on the screen, and the user is provided with the option to select only those of interest. In some embodiments, the user is then presented with the timeline on an individualized basis for each player/object of interest (e.g. each object which the user may have selected in a user interface or via preference settings as being of interest to the user). The user is then provided with the ability to select each of these entities on an individual basis or combinations thereof.

In exemplary embodiments, the end user is visually cued (e.g. with an icon or color selection with bands beneath the timeline axis) for the availability of zoom coded streams within the time window of observation. The end user may then fast forward, rewind, or seek to the vicinity of the zoom coded stream or stream of interest (e.g. using an IR remote control, a touch screen interface, or other suitable input device). For example, the user may use such an input device to select or touch a portion of an object-annotated timeline in order to select an object of interest at an available time, and in response the client device may request, retrieve, decode and display segments of the associated zoomcoded stream beginning at the selected time. This may be done using a single timeline view as depicted in FIGS. 5 and 6, or may be done using the multiple ‘stacked’ timeline view described previously. In either case, a single selection action by the user along an object-annotated timeline may simultaneously select the zoomcoded object to display and the seek time desired for display of the object. In another embodiment, the user is provided with the ability to jump to specific zoom coded streams of the same character/object by repeatedly selecting or touching the icon representing the character/object. In live content, such features are available only for the past, but for VOD content, such features may be offered for data in both directions (past and future) relative to the current viewing time. All these mechanisms are possible because the metadata describing the zoom coded streams on a per character/object basis are available (in the past for LIVE and in both directions for VOD), as described using Dynamic Adaptive Streaming over HTTP (DASH) or other proprietary mechanisms. The relevant data is sent to the client device from the headend. This enables a client device to visually present this information to an end user to enable easy interaction.

In a further embodiment, the client device (based on end-user selection of one or more tracked objects of interest to the user) concatenates together only the scenes or regions (e.g. the timeline intervals) which contain the tracked objects of interest to the user. The client device may then present to the end user a collage of the action with automated editing which stitches together the zoom coded streams of the object, player or scene of interest, for example. In some embodiments, based on past viewing experiences of users, the client device is cued to automatically select certain objects/characters/ROIs based on the incoming data. For example, if a user has in the past tended to select a particular soccer player when watching video content of a particular soccer team, the client device may identify that the same soccer player is available as a zoom coded stream in the current video presentation, and so the client may automatically select the same soccer player in order to present the zoom coded stream content of that soccer player to the user. Other well-known attributes, such as a player's jersey number in a game or their name, may be pre-selected by a user in a user profile or at the start of a game or during the watching session. With this information, it will be possible to create a personalized collage of scenes involving that player specifically for the end user.

### An Example of Zoom Coding Enablement in the Client Using MPEG-DASH.

MPEG-DASH (ISO/IEC 23009-1:2014) is a new ISO standard that defines an adaptive streaming protocol for media delivery over IP networks. DASH is expected to become widely used (in replacement of current proprietary schemes such as Apple HLS, Adobe Flash, and Microsoft Silverlight. The following embodiments outline the delivery of zoom coding using MPEG DASH.

In some embodiments, the client device in a zoom coding system follows the following process:
1) Determine that a zoom coded representation is available and how to access that content. This is signaled to the DASH Client using syntax in the MPD (media presentation descriptor). As described in Amendment 2 of the ISO DASH standard, the MPD provides a “supplementary stream.” This supplementary stream may be utilized for zoom coding. In some embodiments, a Spatial Relationship Descriptor (SRD) syntax element is describe a spatial portion of an image (see Annex H of ISO 23009-1 AM2).
2) Use the object render point provided in the video bit stream to render the zoomed section with motion for the object being tracked. The object (or objects) render point may be sent in user data for one or more slices as a supplemental enhancement information (SEI) message, for example. Zero or more objects may be signaled per slice.

In an exemplary embodiment, Slice User Data for object render points includes the following information:

Object_ID: Range 0-255. This syntax element provides a unique identifier for each object.
Object_x_position[n]: For each object ID n, the x position of the object bounding box.
Object_y_position[n]: For each object ID n, the y position of the object bounding box.
Object_x_size_in_slice[n]: For each object ID n, the x_dimension of the object bounding box.
Object_y_size_in_slice[n]: For each object ID n, the y_dimension of the object bounding box.

The object bounding box represents a rectangular region that encloses the object. In an exemplary embodiment, the (x, y) position is the upper left corner position of the object bounding box. Some objects may be split across more than 1 slice during certain frames. In this case, the object position and size may pertain to the portion of the object contained in the slice that contains the user data.

The position and size data described above may be slice-centric and may not describe the position and size of the entire object. The object bounding box may be the union of all the slice-centric rectangular bounding boxes for a given object.

In some embodiments, it is possible that the overall object bounding box is not rectangular. However, for purposes of display on a standard rectangular screen, these unions of the object bounding boxes are illustrated herein as being rectangular.

Using the Object_ID, and the position and size information in the client device, regions may be rendered on screen. This information may be updated (e.g. periodically or constantly updated) through the SEI messages. As shown in FIG. 3, three objects of interest have available zoom coded streams and may be presented as separate zoom regions. They will each have different Object_IDs, and will evolve over time differently.

In an exemplary embodiment, when a user makes a selection on the client device (e.g. by pressing a button) to get information on the zoom coded streams that may be downloaded/tracked, the client device responds by displaying the bounding boxes on a static image. In some embodiments, the static image is a frame of video that was stored on the server. The static image may be a single image decoded by the client from a video segment received from the server. The static image may be, for example, the frame most recently decoded by the client, a recently received IDR frame, or a frame selected by the client to contain all of the available tracked objects or a maximum number of the available tracked objects. Other alternatives include the use of manually annotated sequences using templates of specific characters. For example, the static image may be the image of a player who is being tracked in the sequence. The user could, for example, recognize the player and request all zoom coded streams of that character that are available.

The user provides input through, for example, a mouse or a simple numbering or color coded mechanism to select one or more of the zoom coded objects. Based on the user input, the server starts to stream the appropriate zoom coded stream to the user's client device. In FIG. 3, for example, the user might pick object 320, the soccer ball. The user's selection of object 320 is translated to the appropriate stream request, which is sent to the server. The stream request may request a single zoom coded stream corresponding to the selected object, or it may request multiple zoom coded streams corresponding to the portions or slices which together make up the selected object. The server then serves the zoom coded stream or streams to the client device, and in this example, displays the selected object of interest, the soccer ball.

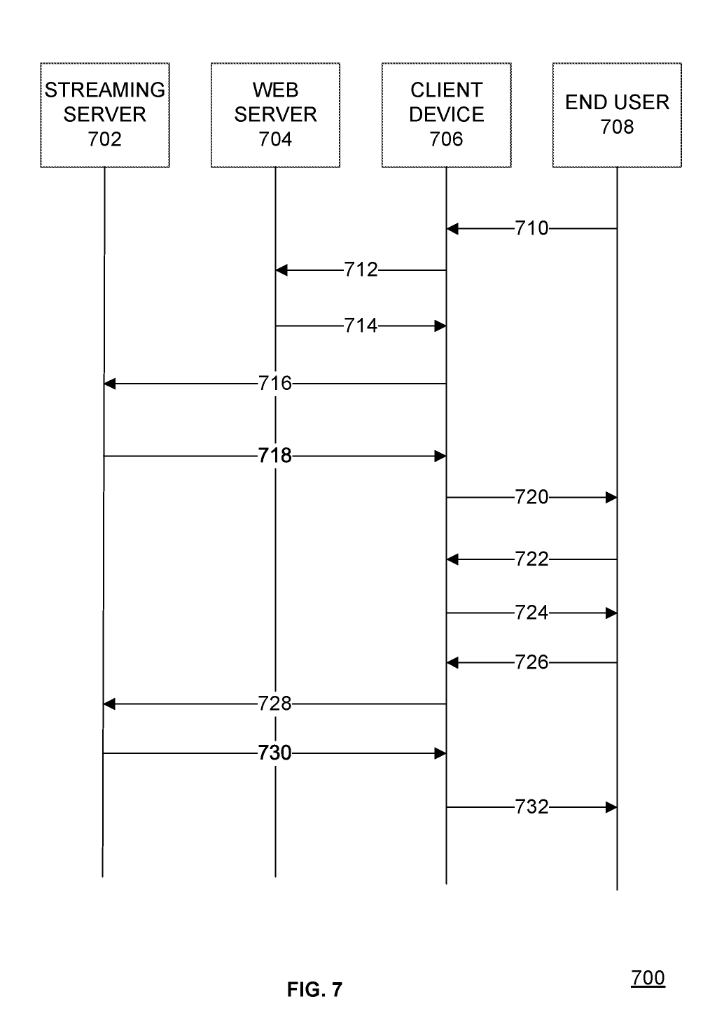

FIG. 7 depicts an example of an overall flow, including presentation of zoom coded streams to the user, of the zoom coding scheme, in accordance with an embodiment. FIG. 7 depicts the flow 700 illustrating interactions between a streaming server 702, a web server 704, a client device 706, and an end user 708.

When the end user 708 makes a program request (at 710), the client device sends a request message to the web server 704 (at 712) and the web server 704 redirects (at 712-716) the request to the appropriate streaming server 702. The streaming server 702 sends down the appropriate manifest (at 718) of media presentation descriptor file (including the zoom coded stream options) to the user's client device 706. The normal program is then decoded and displayed (at 720). (The normal program may correspond to one or more of the traditional ABR streams as depicted in FIG. 2, which may be selected and/or requested by the client, for example). When an end user 708 makes a request to see what zoom options are available (at 722), the client device 706 creates a composite of the available zoom option streams (at 724) e.g. on a still image and sends this still image to the display on client device 706. The end user 708 then makes a selection (at 726) of the zoom coded stream that the user wants to follow. In some embodiments, this may be done with an advanced remote control by appropriately moving an arrow to the location of the image. On a standard remote control, a number selection mechanism may be employed, wherein each region is labelled with a number that is then selected using the number pad. Alternately the end user 708 may navigate among the selections using directional keys (up, down, left, right) on the remote control, and may push a button on the remote to select a currently highlighted object or object portion. When a specific zoom program is selected by the end user 708, the client device 706 sends (at 728) the request back to the streaming server 702 which then delivers (at 730) the appropriate representation of the zoom stream. (The zoom stream may adapt like a conventional ABR stream to network conditions). The client device 706 then decodes and displays (at 732) the zoom stream to the end user 708.

Client Exchange with Network Based on User Input.

In at least one embodiment, the client device requesting the zoom coded information performs the following steps:
a) The client device receives the “manifest” (or media presentation descriptor, MPD in DASH) which contains information on the zoom-coded streams available and which slices constitute the current zoom-coded frame.
b) The client device presents the manifest information to the end user on the user interface. The metadata made available to the end-user may be presented in a variety of ways. One example is a static image with the traceable objects. Another view is a listing of all objects that may be tracked in a specified time-window. Yet another representation is an object number that may be, for example, selected with a remote controller. The user interface may, for example, take any of the forms illustrated in FIGS. 3-6.
c) The client device receives the selection from the user of a zoomed stream that the user wishes to view. The user's selection is translated into a request that is sent by the client device to the server. The slices corresponding to the requested stream are sent down to the client device. If an in-band method is used for communication of render point information, the stream includes the render-point information in the appropriate slice or slices.
d) If the zoom coded streams are ABR coded, the client device requests appropriate representations of the zoom coded streams.
e) It is possible that more than one zoom coded object may be tracked and each of these may have a completely different, partially overlapping or fully overlapping set of slices. The render point information for each set would be independently codified for each such set and may be contained in different slices or the same slice. The client device retrieves the appropriate render point (corresponding to the current zoom coded object stream) and applies the render point offset accordingly.
f) As the object moves through the screen (for example), there may be a change of slices that represent the new zoomed view. In this case, the manifest may be updated to signal the change. (Alternatively, other mechanisms may be used instead of an entirely new manifest.) The client device then uses the updated manifest information to appropriately request the set of slices that represent the updated view.
g) In some embodiments, the client device requests all the slices individually corresponding to the current object stream. In other embodiments, the client device issues a request using the object ID based on which the server then delivers the entire slice set that corresponds to the current object stream. (The mechanism to do this may be in-band or out-of-band.)
h) In some embodiments, the client device may request zoom coded stream data only for the time intervals for which the object or objects selected by the user are available. The client device may determine the appropriate time intervals based on the out of band metadata which describes the available tracked objects and which indicates the availability times. Such metadata may, as described previously, include various start times and tracking durations for each of the available tracked objects.

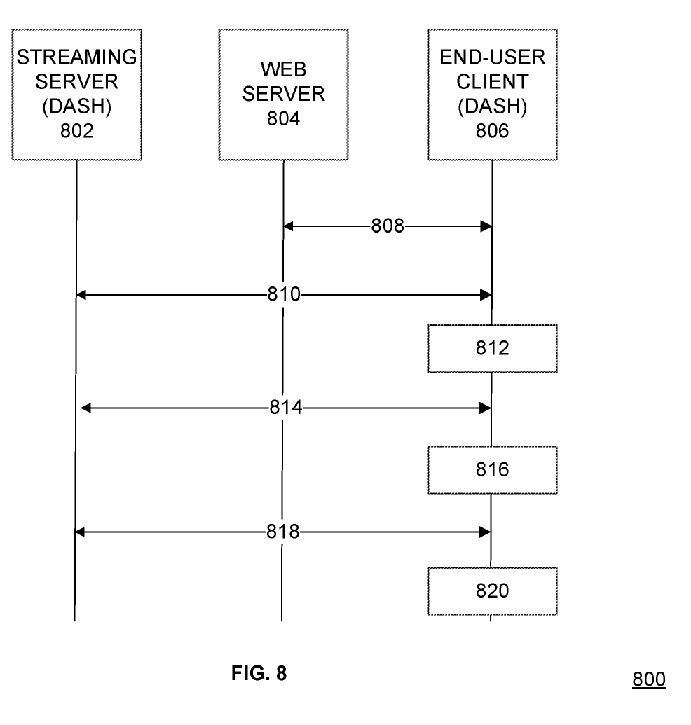

FIG. 8 depicts an example of such an information exchange (with the individual slice requests) for a typical DASH-type session, in accordance with an embodiment. In particular, FIG. 8 depicts a flow 800 for a typical DASH-type session exchange. The flow 800 depicts interactions between a DASH-type streaming server 802, a web server 804, and a DASH-type end-user client 806. At 808, the web server 804 receives a content request from the client device 806 and provides a streaming server redirect to the end-user client device 806. At 810, the end-user client device 806 requests the content from the streaming server 802 and receives an MPD, which may be an extended MPD with zoom-coded stream availability information. At 812, the end-user client device 806 interprets objects available, interprets slices to be requested for each object, and forms an HTTP request for a first slice. At 814, the end-user client device 806 transmits the HTTP request for the first slice to the streaming server 802 and receives from the streaming server 802 an HTTP response for the first slice. At 816-818, the end-user client device 806 repeats 812-814 for each additional slice requested. At 820, the end-user client device 806 composes the zoom-coded frame for the requested objects for display. Some extensions to DASH may be implemented to support the functionality of tracking multiple objects with overlapping slices that may need to be retrieved to render those objects. (The term “DASH-type” refers herein to an exchange that makes use of features not yet implemented in DASH.)

### Other Variations.

In some embodiments, multiple views of the zoom coded information may be provided in full, original resolution, in a picture-in-picture type of display. In some embodiments, the various zoom coded views are presented in a tiled format.

Some embodiments enable smooth switching between the overall unzoomed view and zoom coded view with a one touch mechanism (either at remote or keyboard or tablet)

In some embodiments, the client device allows automatic switching to a zoom coded view (even without the user being cued). Such an embodiment may be appealing to users who merely want to track that users' objects of interest. In such an embodiment, users are able to track an object of interest without going through the highlighting mechanism. As an example, a user could set a preference in their client device that they would like to see a zoom coded view of their favorite player whenever the player is in the camera's field of view. Some such embodiments incorporate a training mode for users to specify such preferences ahead of the presentation.

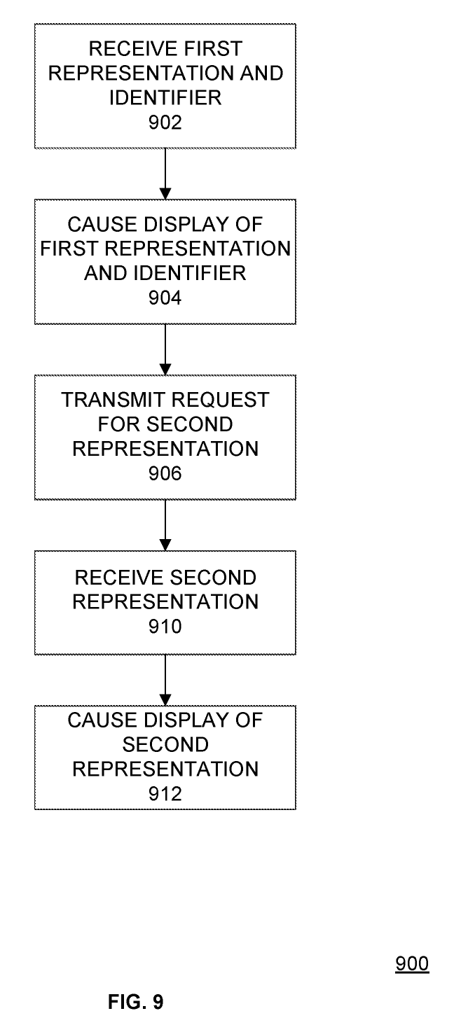

FIG. 9 depicts an example method, in accordance with an embodiment. In particular, FIG. 9 depicts the method 900. The method 900 includes receiving a first representation and identifier at 902, causing display of first representation and identifier at 904, transmitting a request for a second representation at 906, receiving the second representation at 910, and causing a display of the second representation at 912.

At 902, the first representation of the video stream and the object-of-interest identifier is received from a content server. The object-of-interest identifier indicates an availability of a second representation of a portion of the video stream that depicts the object of interest. At 904, both the first representation of the video stream and the object-of-interest identifier are caused to be displayed at a client device. At 906, in response to a user selection of the second representation of the portion of the video stream (e.g. selection of the displayed object-of-interest identifier by the user), a request for the second representation of the portion of the video stream is transmitted to the content server. At 910, the second representation of the portion of the video stream is received, and at 912, the second representation of the portion of the video stream is displayed.

Although features and elements are described above in particular combinations, one of ordinary skill in the art will appreciate that each feature or element may be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-15. (canceled)

16. A method comprising:
receiving, from a content server, (i) a lower-resolution representation of a video stream, (ii) metadata identifying each of a plurality of objects in the lower-resolution video stream, and (iii) metadata identifying, for each of the identified objects of interest, at least one corresponding time interval during which the respective object of interest appears in at least one higher-resolution representation of the video stream;
in response to a user selection, automatically:
determining a selected set of at least one of the identified objects;
retrieving at least portions of the at least one higher-resolution representation that include the corresponding time intervals of the selected objects; and
generating a video collage by concatenating the portions of the at least one higher-resolution representation that include the corresponding time intervals of the selected objects; and
displaying the video collage to the user.

17. The method of claim 16, wherein the selected set of identified objects is determined based on explicit selection by the user.

18. The method of claim 16, wherein the selected set of identified objects is determined based on past viewing experiences of the user.

19. The method of claim 16, wherein the selected set of identified objects is determined based on user profile data.

20. The method of claim 16, wherein the metadata is received in a media presentation description (MPD).

21. The method of claim 16, wherein the higher-resolution representation is a zoomed representation of a spatial portion of the video.

22. A video client device operative to perform functions comprising:
receiving, from a content server, (i) a lower-resolution representation of a video stream, (ii) metadata identifying each of a plurality of objects in the lower-resolution video stream, and (iii) metadata identifying, for each of the identified objects of interest, at least one corresponding time interval during which the respective object of interest appears in at least one higher-resolution representation of the video stream;
in response to a user selection, automatically:
determining a selected set of at least one of the identified objects;
retrieving at least portions of the at least one higher-resolution representation that include the corresponding time intervals of the selected objects; and
generating a video collage by concatenating the portions of the at least one higher-resolution representation that include the corresponding time intervals of the selected objects; and
displaying the video collage to the user.

23. The video client of claim 22, wherein the selected set of identified objects is determined based on explicit selection by the user.

24. The video client of claim 22, wherein the selected set of identified objects is determined based on past viewing experiences of the user.

25. The video client of claim 22, wherein the selected set of identified objects is determined based on user profile data.

26. The video client of claim 22, wherein the metadata is received in a media presentation description (MPD).

27. The video client of claim 22, wherein the higher-resolution representation is a zoomed representation of a spatial portion of the video.
